(19) United States
(12) Patent Application Publication
(10) Pub. No.: US 2026/0009724 A1
(43) Pub. Date: Jan. 8, 2026

(54) DATA PROCESSING METHOD, NON-TRANSITORY COMPUTER-READABLE RECORDING MEDIUM, PROCESSING APPARATUS, AND GAS ABSORPTION SPECTROSCOPY SYSTEM

(71) Applicant: SHIMADZU CORPORATION, Kyoto-shi (JP)

(72) Inventor: Yuta KAWASHIMA, Kyoto-shi (JP)

(21) Appl. No.: 19/260,149

(22) Filed: Jul. 3, 2025

(30) Foreign Application Priority Data
Jul. 5, 2024 (JP) 2024-108794

(51) Int. Cl. G01N 21/31

(52) U.S. Cl. CPC G01N 21/31; G01N 2201/121; G01N 2201/126

(57) ABSTRACT

A data processing method includes a step of acquiring reference data, a step of acquiring target data, a step of generating an interpolation function based on the reference data, a step of acquiring corrected data by correcting the target data based on the interpolation function, and a step of quantifying a target component based on the corrected data. The step of generating the interpolation function includes a step of extracting a reference signal from a region where a signal intensity is equal to or less than a threshold in the reference data, a step of predicting the signal intensity of the reference data based on the reference signal and acquiring prediction data, and a step of deriving a correspondence relationship between the prediction data and the reference data as the interpolation function.

### TECHNICAL FIELD

The present disclosure relates to a data processing method, a non-transitory computer-readable recording medium, a processing apparatus, and a gas absorption spectroscopy system, and more particularly, to data processing for correcting data obtained by gas absorption spectroscopy.

### BACKGROUND ART

Cavity ring-down spectroscopy (CRDS) is known as one type of gas absorption spectroscopy. CRDS is a measurement method for determining the concentration of a target component contained in a gas with high sensitivity by lengthening the effective optical path length for light absorption by the gas using a resonator (cavity) configured to include high-reflectivity mirrors. Information regarding a gas absorption spectrometer using CRDS is disclosed, for example, in “Survey and Research on High-Efficiency Measurement Technology for Trace Moisture in Gas,” by Koji Hashiguchi, AIST Measurement Standard Report, Vol. 9, No. 2, October 2015 (Non-Patent Document 1).

In CRDS, after light (laser light) is accumulated in a resonator, the light input to the resonator is blocked, and the attenuation of the light leaking from the resonator after the light is blocked is measured by a photodetector. The concentration of the target component contained in the gas in the resonator is measured by determining the time constant of the light attenuation (ring-down time) from the measured data.

In CRDS, it is necessary to accurately observe the process of exponential decay of the light leaking from the resonator. Therefore, it is required to use a photodetector with good linearity. However, it is known that many highly sensitive mid-infrared detectors have a non-linear response characteristic with respect to the amount of light. Therefore, data processing methods for removing the non-linear component contained in the measurement data acquired by the photodetector and correcting the measurement data have been studied.

Regarding the correction of measurement data acquired by a photodetector, Japanese Unexamined Patent Application Publication No. Hei 11-23367 (Patent Document 1) and “Nonlinearity Correction of Photoconductive MCT Detector in Infrared Fourier Transform Spectroscopy,” Spectroscopy Research, Vol. 46, No. 3 (1997) (Non-Patent Document 2) disclose a method of acquiring parameters of a model function from reference data and correcting the measurement data.

### PRIOR ART DOCUMENTS

### Patent Documents

Patent Document 1: Japanese Unexamined Patent Application Publication No. Hei 11-23367

### Non-Patent Documents

Non-Patent Document 1: “Survey and Research on High-Efficiency Measurement Technology for Trace Moisture in Gas,” Koji Hashiguchi, AIST Measurement Standard Report, Vol. 9, No. 2, October 2015

Non-Patent Document 2: “Nonlinearity Correction of Photoconductive MCT Detector in Infrared Fourier Transform Spectroscopy,” Spectroscopy Research, Vol. 46, No. 3 (1997)

### SUMMARY OF THE INVENTION

### Problem to be Solved by the Invention

In the methods disclosed in Patent Document 1 and Non-Patent Document 2, the non-linear component in the acquired measurement data can be removed based on a model function to correct the measurement data. However, the non-linear component of the data acquired by a photodetector in a CRDS measurement may not fit the model function. In such a case, if the concentration of a component in a sample gas is calculated using the data corrected by the above method, the measurement accuracy of the concentration of the component may decrease. Therefore, there is a need for a data processing method that can correct measurement data obtained by gas absorption spectroscopy without using a model function.

The present disclosure has been made in view of such circumstances, and its object is to correct measurement data obtained by gas absorption spectroscopy without using a model function.

### Means For Solving The Problem

A data processing method according to a first aspect of the present disclosure is a data processing method for correcting target data obtained by a gas absorption spectroscopy method using a resonator. The data processing method includes (A) a step of acquiring reference data, (B) a step of acquiring target data, (C) a step of generating an interpolation function based on the reference data, (D) a step of acquiring corrected data by correcting the target data based on the interpolation function, and (E) a step of quantifying a target component based on the corrected data. The step of generating the interpolation function includes (a) a step of extracting a reference signal from a region where a signal intensity is equal to or less than a threshold in the reference data, (b) a step of predicting the signal intensity of the reference data based on the reference signal and acquiring prediction data, and (c) a step of deriving a correspondence relationship between the prediction data and the reference data as the interpolation function.

A processing apparatus according to a second aspect of the present disclosure includes at least one or more processors and a memory accessible to the one or more processors. The memory stores one or more instructions to be executed by the processors. The processors, by executing the one or more instructions, acquire reference data, acquire target data, generate an interpolation function based on the reference data, correct the target data based on the interpolation function, acquire corrected data, and quantify a target component based on the corrected data. The processors, when generating the interpolation function, extract a reference signal from a region where a signal intensity is equal to or less than a threshold in the reference data, predict the signal intensity of the reference data based on the reference signal, acquire prediction data, and derive a correspondence relationship between the prediction data and the reference data as the interpolation function.

A gas absorption spectroscopy system according to a third aspect of the present disclosure is a gas absorption spectroscopy system for quantifying a target component in a gas contained in a cell. The gas absorption spectroscopy system includes a resonator including a plurality of mirrors arranged such that light is reflected between them inside the cell, a light source that irradiates the resonator with laser light, a detector that detects light extracted from the resonator, and a control device that receives a detection signal from the detector. The control device acquires reference data, acquires target data, generates an interpolation function based on the reference data, corrects the target data based on the interpolation function, acquires corrected data, and quantifies the target component based on the corrected data. The control device, when generating the interpolation function, extracts a reference signal from a region where a signal intensity is equal to or less than a threshold in the reference data, predicts the signal intensity of the reference data based on the reference signal, acquires prediction data, and derives a correspondence relationship between the prediction data and the reference data as the interpolation function.

### Effects of the Invention

According to the present disclosure, it is possible to correct measurement data obtained by gas absorption spectroscopy without using a model function.

### BRIEF DESCRIPTION OF THE DRAWINGS

FIG. 1 is a diagram schematically showing the configuration of a gas absorption spectroscopy system.

FIG. 2 is a conceptual diagram for explaining mode frequencies.

FIG. 3 is an example of a ring-down signal obtained by measurement using the gas absorption spectroscopy system.

FIG. 4 is a diagram for explaining an absorption spectrum.

FIG. 5 is a diagram for explaining a method of generating an interpolation function.

FIG. 6 is a diagram for explaining a method of setting a threshold.

FIG. 7 is a diagram for explaining a fitting residual.

FIG. 8 is a diagram for explaining the timing of acquiring reference data.

FIG. 9 is a flowchart showing a data processing method according to an embodiment.

FIG. 10 is a flowchart showing a subroutine of step S14 shown in FIG. 9.

### DESCRIPTION OF EMBODIMENTS

Hereinafter, embodiments of the present disclosure will be described in detail with reference to the drawings. Note that the same or corresponding parts in the drawings are denoted by the same reference numerals, and description thereof will not be repeated.

### Apparatus Configuration

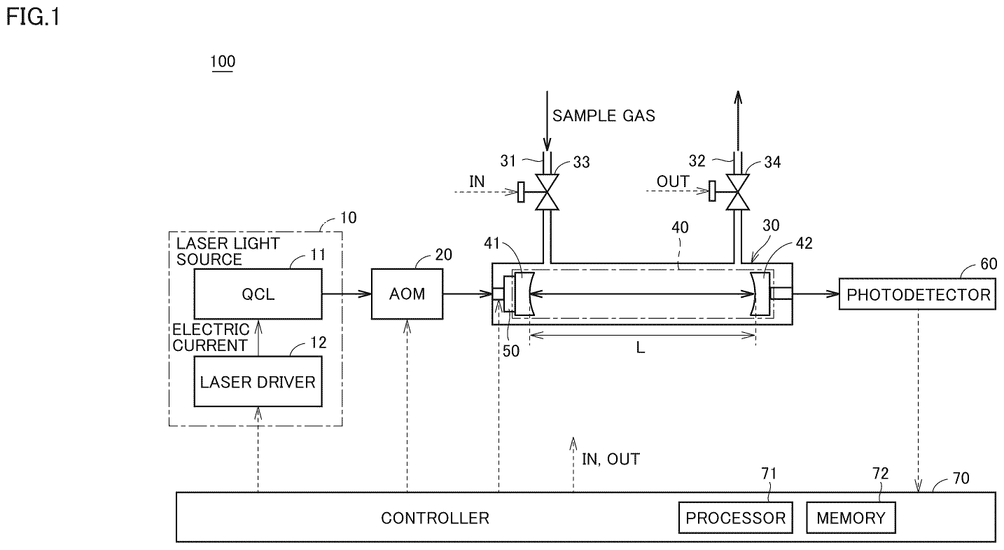

FIG. 1 is a block diagram schematically showing the overall configuration of a gas absorption spectroscopy system according to an embodiment. Referring to FIG. 1, the gas absorption spectroscopy system 100 is a spectroscopy system that measures light absorption by a target component contained in a gas to be measured (sample gas) by cavity ring-down absorption spectroscopy (CRDS).

The gas absorption spectroscopy system 100 includes a laser light source 10, an AOM (Acousto-Optic Modulator) 20, a cell 30, a resonator 40, a mirror driving device 50, a photodetector 60, and a controller 70.

The laser light source 10 irradiates the resonator 40 with laser light. The laser light source 10 is configured to be capable of varying the oscillation frequency of the laser light in accordance with a command from the controller 70. Specifically, the laser light source 10 includes a distributed feedback type quantum cascade laser (QCL) 11 and a laser driver 12. The QCL 11 emits laser light with a center oscillation frequency of, for example, about 2200 cm−1 (wavelength of about 4.5 μm). The laser driver 12 supplies a drive current to the QCL 11 in accordance with a command from the controller 70. By changing the drive current to the QCL 11, the oscillation frequency of the QCL 11 can be swept by about 0.2 cm−1.

The AOM 20 is provided in the optical path between the laser light source 10 and the resonator 40. The AOM 20 is an optical switch (switching device) that switches between irradiation and blocking of the laser light from the laser light source 10 to the resonator 40 at high speed in accordance with a command from the controller 70. The AOM 20 enters an ON state in which it outputs the laser light from the laser light source 10 to the resonator 40 when an ON command for irradiating light is applied from the controller 70. The AOM 20 enters an OFF state in which it does not output the laser light from the laser light source 10 to the resonator 40 when an OFF command for blocking light is applied from the controller 70.

The cell 30 is a container capable of sealing a sample gas, and has, for example, a cylindrical shape. An introduction pipe 31 for introducing the sample gas before the start of measurement and a discharge pipe 32 for discharging the sample gas after the end of measurement are connected to the cell 30. An introduction valve 33 is provided in the introduction pipe 31. A discharge valve 34 is provided in the discharge pipe 32. The opening and closing of the introduction valve 33 and the discharge valve 34 can be controlled by the controller 70.

The resonator 40 is provided between the AOM 20 and the photodetector 60. In the embodiment, the resonator 40 is a Fabry-Perot type optical resonator. A pair of mirrors 41 and 42 are provided inside the resonator 40. The mirrors 41 and 42 are arranged opposite each other such that light is reflected between them inside the resonator 40. Each of the mirrors 41 and 42 has a concave surface to easily satisfy the stability condition of the resonator 40. Also, each of the mirrors 41 and 42 has a high reflectivity (for example, about 99.9%) so that the light leaking to the outside of the resonator 40 is extremely weak. The resonator length of the resonator 40 (the distance in the optical axis direction between the mirrors 41 and 42) is, for example, about 450 mm. The number of mirrors arranged inside the resonator 40 is not limited to two, and may be three or more. That is, it may be a resonator in which mirrors are arranged such that light is reflected between them, or a resonator in which mirrors are arranged in a ring shape such that light is reflected in one direction.

In the embodiment, the resonator length of the resonator 40 is the distance between the mirror 41 and the mirror 42 in the direction connecting the mirror 41 and the mirror 42 (optical axis direction). Hereinafter, this resonator length is represented by L. The resonator length L is, for example, 30 cm.

In the example shown in FIG. 1, both the mirrors 41 and 42 are concave mirrors. However, both the mirrors 41 and 42 do not have to be concave mirrors. At least one of the mirrors 41 and 42 may be a concave mirror. For example, one of the mirrors 41 and 42 may be a concave mirror and the other may be a plane mirror.

The mirror driving device 50 drives the mirror 41 constituting the resonator 40 in accordance with a command from the controller 70. In the present embodiment, the mirror driving device 50 includes an actuator. Each actuator is a piezo element (piezoelectric element) having a donut-shaped hole for passing light. The piezo element displaces the mirror 41 in the optical axis direction.

The photodetector 60 is a photodetector such as a photodiode or an image sensor. The photodetector 60 detects weak light extracted from the mirror 42 of the resonator 40 as output light of the resonator 40, and outputs a signal indicating the detection result (detection signal) to the controller 70. For example, a liquid nitrogen-cooled InSb (indium antimonide) detector and an MCT detector can be used as the photodetector 60.

The controller 70 includes a processor 71 such as a CPU (Central Processing Unit) or an FPGA (Field-Programmable Gate Array), a memory 72 such as a ROM (Read Only Memory) and a RAM (Random Access Memory), and an input/output port (not shown).

The controller 70 controls each device constituting the gas absorption spectroscopy system 100. Specifically, the controller 70 outputs a command for scanning the oscillation frequency of the laser light to the laser driver 12, or outputs the above-mentioned ON signal or OFF signal to the AOM 20. The controller 70 outputs a command for introducing the sample gas into the resonator 40 to the introduction valve 33, or outputs a command for discharging the sample gas to the outside of the resonator 40 to the discharge valve 34. The controller 70 applies a voltage for displacing the mirror 41 to the piezo element of the mirror driving device 50. Also, the controller 70 executes various data processing for calculating the concentration (absolute concentration) of the target component contained in the sample gas based on the detection signal from the photodetector 60.

The controller 70 may be configured by being divided into two or more units for each function. For example, the controller 70 may be divided into a unit that controls each device and a unit that executes various data processing.

### Measurement Principle by Cavity Ring-Down Absorption Spectroscopy (CRDS)

The measurement principle by cavity ring-down absorption spectroscopy in the gas absorption spectroscopy system 100 will be briefly described. In general, resonance occurs when the frequency of the irradiated laser light and the resonator length L satisfy a predetermined relationship. Hereinafter, the frequency of the laser light irradiated to the resonator 40 is referred to as “laser frequency,” and the frequency of the laser light at which resonance can occur due to the resonator 40 is referred to as “mode frequency.”

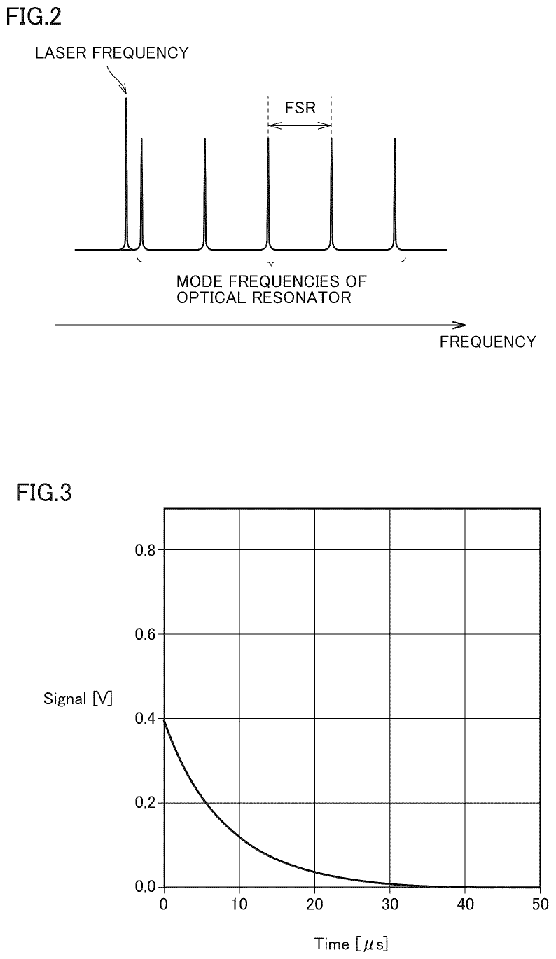

FIG. 2 is a conceptual diagram for explaining the mode frequency. As shown in FIG. 2, there are a plurality of mode frequencies at a predetermined frequency interval. Hereinafter, the interval between two adjacent mode frequencies among the plurality of mode frequencies is referred to as “free spectral range” (FSR).

The resonance condition, which is the condition for resonance to occur, is that twice the resonator length L is an integer multiple of the wavelength λ of the laser light. Therefore, when the following equation (1) is satisfied, the resonator 40 enters a resonance state.

$$2 L = q λ \qquad ( 1 )$$

In equation (1), q is an integer.

Here, the relationship between the wavelength λ of the laser light and the laser frequency v is expressed by the following equation (2) using the speed of light c.

$$c = λ v \qquad ( 2 )$$

Therefore, from equations (1) and (2), the resonance condition is expressed by the following equation (3).

$$v = qc / 2 L \qquad ( 3 )$$

There are a plurality of v that satisfy this condition, and each frequency is a mode frequency of the resonator. Also, from equation (3), the FSR, which is the interval between two adjacent mode frequencies among the plurality of mode frequencies, is expressed by c/2L.

When the laser frequency does not coincide with any of the mode frequencies, the power of the light is not stored in the resonator 40. On the other hand, when the laser frequency coincides with any of the mode frequencies, the power of the light is stored in the resonator 40.

The controller 70 determines whether the power of the laser light has been sufficiently stored in the resonator 40 by the output signal of the photodetector 60 (the output light of the resonator 40). When the output light of the resonator 40 reaches a predetermined threshold, the controller 70 determines that the power of the laser light has been sufficiently stored in the resonator 40 and outputs an OFF signal to the AOM 20. As a result, the light input to the resonator 40 is blocked by the AOM 20. Then, the light stored in the resonator 40 makes a large number of round trips (usually several thousand to several tens of thousands of times) between the mirror 41 and the mirror 42. This light is gradually attenuated as it makes round trips between the mirror 41 and the mirror 42 due to loss due to reflection leakage of the mirrors 41 and 42 and absorption by the target component in the sample gas. Therefore, the output light of the resonator 40 leaking from the mirror 42 is gradually attenuated. In CRDS, by lengthening the distance that the light passes through the sample gas (effective optical path length) using the resonator 40, even if the light absorption by the target component is extremely small, the light absorption can be detected.

The controller 70 acquires the output signal of the photodetector 60 after the light input to the resonator 40 is blocked by the AOM 20 as a “ring-down signal,” and calculates the decay time constant of the acquired ring-down signal as a “ring-down time.” The controller 70 quantifies the target component contained in the sample gas from the calculated ring-down time.

FIG. 3 shows an example of a ring-down signal output by the photodetector 60. As shown in FIG. 3, the signal intensity of the ring-down signal decays exponentially over time. In the ring-down signal, the time at which the signal intensity becomes 1/e of the initial signal intensity is the ring-down time.

The controller 70 acquires the output signal of the photodetector 60 at intervals of, for example, 0.2 μsec, and calculates the ring-down time from the acquired output signal of the photodetector 60. When there is no gas component that absorbs the laser light inside the resonator 40, the ring-down time becomes the decay time constant due to the resonator 40, and thus becomes a substantially constant value. On the other hand, when there is a gas component that absorbs the laser light inside the resonator 40, the ring-down time becomes a value that fluctuates according to the concentration of the gas component. By utilizing this point, the target component can be quantified.

Specifically, assuming that the laser frequency is v, the relationship among the absorption coefficient α(v) of the target component, the absorption cross section σ(v) of the sample, and the number density N is expressed as in the following equation (4).

$$\begin{matrix}( Equation 1 ) & \\ α ( v ) = σ ( v ) N & ( 4 )\end{matrix}$$

As is clear from the above equation (4), when the absorption cross section σ(v) of the sample is known, the component in the sample gas sealed in the cell 30 can be quantified by determining the absorption coefficient α(v) of the target component.

The absorption coefficient α(v) can be calculated according to the following equation (5).

$$\begin{matrix}( Equation 2 ) & \\ α ( v ) = \frac{1}{c} ( \frac{1}{τ ( v )} - \frac{1}{{τ}_{0} ( v )} ) & ( 5 )\end{matrix}$$

In equation (5), τ(v) is the ring-down time when the sample gas fills the cell 30, and τ0(v) is the ring-down time when the sample gas is not introduced into the cell 30 (for example, in a vacuum state).

From the above, by measuring the ring-down time τ(v) when the sample gas fills the cell 30 and the ring-down time τ0(v) when the sample gas is not introduced into the cell 30 by CRDS, the target component can be quantified.

### Absorption Spectrum

As described above, in order to quantify the target component in the sample gas filling the cell 30, it is necessary to determine the ring-down time τ0(v) in a state where the sample gas is not introduced into the cell 30. However, it may be difficult to create a state where the sample gas is not introduced into the cell 30. For example, it may be difficult to completely remove the sample gas from the cell 30. In such a case, the absorption coefficient α(v) can be determined by measuring the absorption spectrum without performing a measurement in a state where the sample gas is not introduced into the cell 30. Hereinafter, a method of measuring the absorption spectrum and determining the absorption coefficient α(v) will be described.

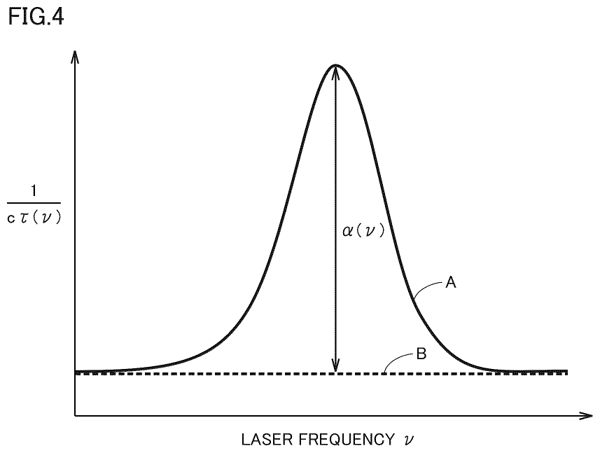

FIG. 4 is a diagram for explaining the absorption spectrum measurement. An absorption spectrum A is obtained by performing a measurement while changing the laser frequency v with the sample gas in the cell 30, and acquiring ring-down signals τ(v) at various frequencies.

In FIG. 4, the vertical axis represents the reciprocal of the product of the ring-down time τ(v) and the speed of light c, and the horizontal axis represents the laser frequency v.

In FIG. 4, a baseline B of the absorption spectrum A, shown by a broken line, corresponds to the reciprocal of the product of the ring-down time τ0 and the speed of light c.

From equation (5), the absorption coefficient α(v) corresponds to the difference between the absorption spectrum A and the baseline B in FIG. 4.

Therefore, by performing a measurement while changing the laser frequency v with the sample gas in the cell 30 and acquiring an absorption spectrum, the target component of the sample gas can be quantified without performing a measurement by CRDS in a state where the sample gas is not introduced into the cell 30.

### Non-linearity of Photodetector

In CRDS, since it is necessary to accurately observe the process of exponential decay, it is desirable that the photodetector used has good linearity. However, it is known that many highly sensitive mid-infrared detectors have a non-linear response characteristic with respect to the amount of light.

Therefore, the data actually obtained by a photodetector in a CRDS measurement is a distorted exponential function due to the non-linearity of the photodetector. The measurement data Sd(t) measured by the photodetector is expressed by the following equation (6).

$$\begin{matrix}( Equation 3 ) & \\ Sd ( t ) = Se ( t ) + N ( Sd ( t ) ) & ( 6 )\end{matrix}$$

In equation (6), Se(t) is the exponential decay of the laser light, which is the necessary information, and N(Sd(t)) is the non-linear component of the photodetector.

As shown in equation (6), the data acquired by a CRDS measurement includes the non-linear component of the photodetector. If the decay rate of the exponential decay is determined using the measurement result in which the non-linear component of the photodetector is superimposed, it may be difficult to extract the exponential decay of the laser light. Therefore, a data processing method for removing the non-linear component of the photodetector from the measurement data is required.

### Comparative Example

As a method for correcting measurement data acquired by a detector, Patent Document 1 and Non-Patent Document 2 disclose a method of acquiring parameters of a model function from measurement data and correcting the measurement data using the created model function.

In the methods disclosed in Patent Document 1 and Non-Patent Document 2, the non-linear component contained in the measurement data can be removed based on a model function to correct the measurement data. However, the non-linear component of the detector may not fit the model function, which may lead to a decrease in correction accuracy. In such a case, if the concentration of a component in a sample gas is calculated using the corrected data obtained by the above method, the measurement accuracy of the concentration of the component may decrease.

### Data Processing Method According to Embodiment

Therefore, in the data processing method according to the embodiment, a signal in a region of a ring-down signal that has weak non-linearity and can be regarded as a linear time change is extracted, and an interpolation function is generated using only the extracted signal. By using the generated interpolation function, the non-linear component of the detector can be removed from the measurement data acquired by the photodetector.

It is generally known that in a ring-down signal, a signal in a region with low signal intensity has weaker non-linearity than a signal in a region with high signal intensity.

In the data processing method according to the present embodiment, the non-linear component of the detector can be removed from the data to be measured without using a model function. Since the correction accuracy of the measured data can be improved, the measurement accuracy of the target component in the sample gas can be improved.

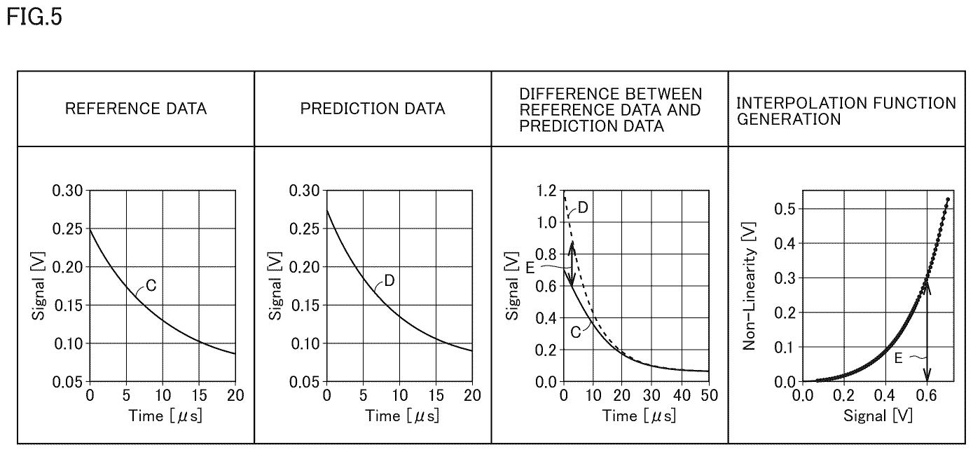

FIG. 5 is a diagram for explaining a method of creating an interpolation function in the data processing method according to the present embodiment.

Referring to FIG. 5, first, the controller 70 acquires reference data C for creating an interpolation function. The reference data C is, for example, a ring-down signal and data in which a plurality of ring-down signals are integrated. The method of acquiring the reference data will be described in detail later.

The controller 70 sets a threshold and extracts a reference signal, which is a signal in a region where the signal intensity is equal to or less than the set threshold in the reference data C. The method of setting the threshold will be described in detail later.

The controller 70 performs an exponential decay fitting on the reference signal and calculates the parameters of the function. The controller 70 acquires prediction data D generated based on the calculated parameters of the function.

The controller 70 calculates the difference between the signal intensity of the reference data C and the signal intensity of the prediction data D at the same measurement time as the reference data C. The prediction data is data predicted by performing an exponential decay fitting on the reference signal, which can be regarded as having a linear time change in the reference data C. Therefore, the difference between the signal intensity of the reference data C and the signal intensity of the prediction data D corresponds to the non-linear component of the photodetector 60 contained in the reference data C.

FIG. 5 shows, as an example of the difference between the signal intensity of the reference data C and the signal intensity of the prediction data D, a difference E with the prediction data D at a measurement point where the signal intensity of the reference data C is 0.6 V. The difference E is approximately 0.3 V.

The controller 70 generates an interpolation function showing the correspondence relationship between the prediction data D and the reference data C.

Specifically, the interpolation function is what shows the relationship between each signal intensity of the reference data C and the difference between the reference data C and the prediction data D at each signal intensity.

In FIG. 5, the horizontal axis of the interpolation function represents the signal intensity of the reference data C, and the vertical axis of the interpolation function represents the difference between the reference data C and the prediction data D. For example, at the measurement point where the reference data C is 0.6 V, the difference E with the prediction data D was 0.3 V, so when the value on the X-axis is 0.6 V, the interpolation function shows 0.3 V.

After acquiring the target data to be corrected, the controller 70 corrects the target data using the generated interpolation function. Specifically, the value of the interpolation function at the signal intensity is added to the signal intensity in the target data, and the corrected target data is obtained.

The controller 70 creates an absorption spectrum using the corrected data and quantifies the target component contained in the sample gas.

### Setting of Threshold

A method of setting a threshold used when extracting a reference signal from reference data will be described. It is generally known that in a ring-down signal, a signal in a region with low signal intensity has weaker non-linearity than a signal in a region with high signal intensity. In the data processing method according to the present embodiment, an interpolation function is generated using a signal in a region where the signal intensity is equal to or less than a threshold in the reference data. Therefore, it is desirable that the signal in the region where the signal intensity is equal to or less than the threshold in the reference data shows a linear time change. Therefore, the validity of the magnitude of the set threshold is judged based on a fitting residual, which will be described later.

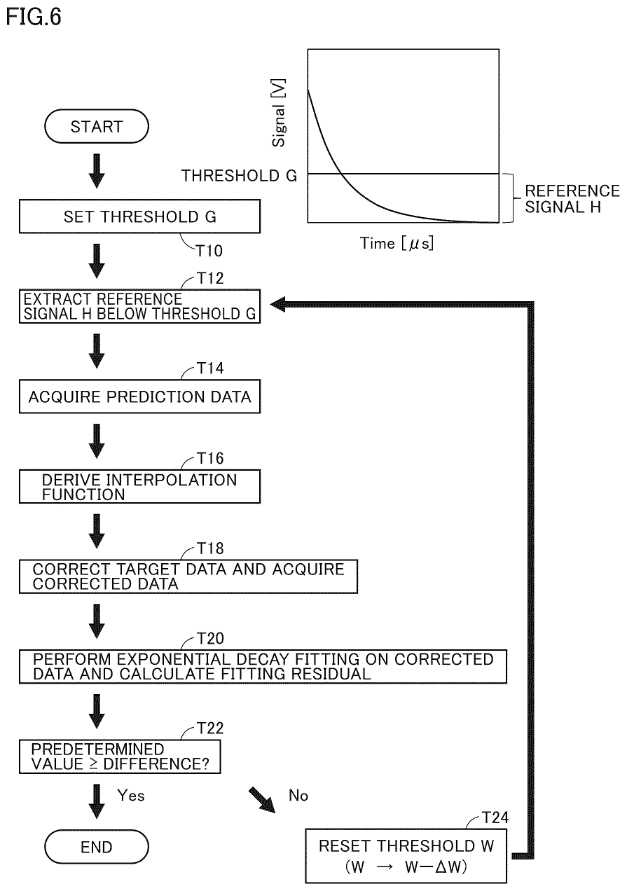

The setting of the threshold will be described with reference to FIG. 6. FIG. 6 is a diagram for explaining a method of setting a threshold based on a fitting residual.

Referring to FIG. 6, in step T10, the controller 70 sets a threshold G. In step T12, the controller 70 extracts a reference signal H in a region where the signal intensity is equal to or less than the threshold G in the reference data.

In step T14, the controller 70 acquires prediction data from the reference signal H. In step T16, the controller 70 derives an interpolation function by the above-described method.

In step T18, the controller 70 corrects the target data using the generated interpolation function and acquires corrected data.

In step T20, the controller 70 performs an exponential decay fitting on the corrected data and calculates a fitting residual.

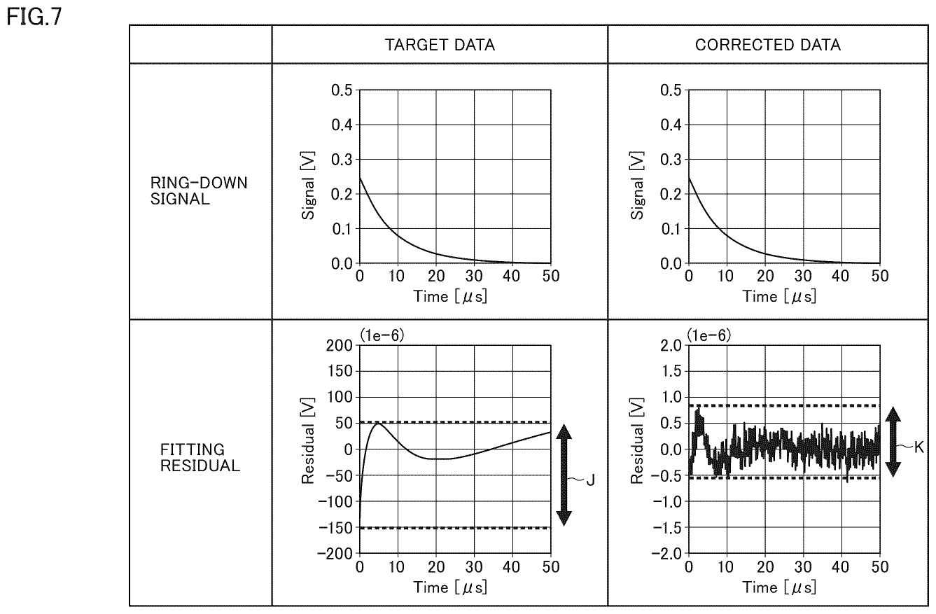

FIG. 7 is a diagram for explaining the fitting residual. The fitting residual is the difference at each measurement point when the corrected data is fitted to an exponential decay.

FIG. 7 shows the fitting residual obtained by fitting the target data, which is the ring-down signal before correction, to an exponential function, and the fitting residual obtained by fitting the corrected data, which is the ring-down signal after correction, to an exponential function.

In FIG. 7, an arrow J and an arrow K indicate the difference between the maximum value and the minimum value in each fitting residual. The magnitude of the arrow J is 200 μV. The magnitude of the arrow K is 1.3 μV.

Here, the smaller the fitting residual, the closer the change in the ring-down signal is to an exponential decay. In FIG. 7, the arrow K, which is the difference between the maximum value and the minimum value of the fitting residual of the corrected data after correction, is smaller than the arrow J, which is the difference between the maximum value and the minimum value of the fitting residual of the target data before correction. This indicates that the non-linear component of the photodetector 60 contained in the target data is removed by the correction, and the exponential decay of the laser light is extracted in the corrected data.

Returning to FIG. 6, the controller 70 determines whether the difference between the maximum value and the minimum value in the fitting residual is smaller than a predetermined value. If the difference is equal to or less than the predetermined value (YES in step T22), the controller 70 determines that the non-linear component of the photodetector 60 contained in the target data has been removed, and completes the generation of the interpolation function. If the difference is larger than the predetermined value (NO in step T22), the controller 70 determines that the non-linear component of the photodetector 60 contained in the target data remains in the corrected data. Therefore, the controller 70 reduces the threshold (step T24) and generates the interpolation function again.

The predetermined value may be determined in advance by a provider or the like of the gas absorption spectroscopy system 100, or may be determined by a user. The predetermined value is, for example, 2 μV.

When the user inputs a predetermined value to the controller 70 via an input device (not shown), the user can adjust the degree of removal of the non-linear component in the target data via the input of the predetermined value.

By reducing the threshold, the non-linearity in the reference signal is weakened. Therefore, by reducing the threshold, the non-linear component of the target data can be further removed.

### Acquisition of Reference Data

In the data processing method according to the present embodiment, an interpolation function is created based on the non-linearity of the photodetector 60 in the reference data. Therefore, the non-linear component of the photodetector 60 in the reference data is removed from the target data.

Since the non-linear component of the photodetector 60 changes over time, it is desirable that the timing of acquiring the target data and the timing of acquiring the reference data are not temporally separated.

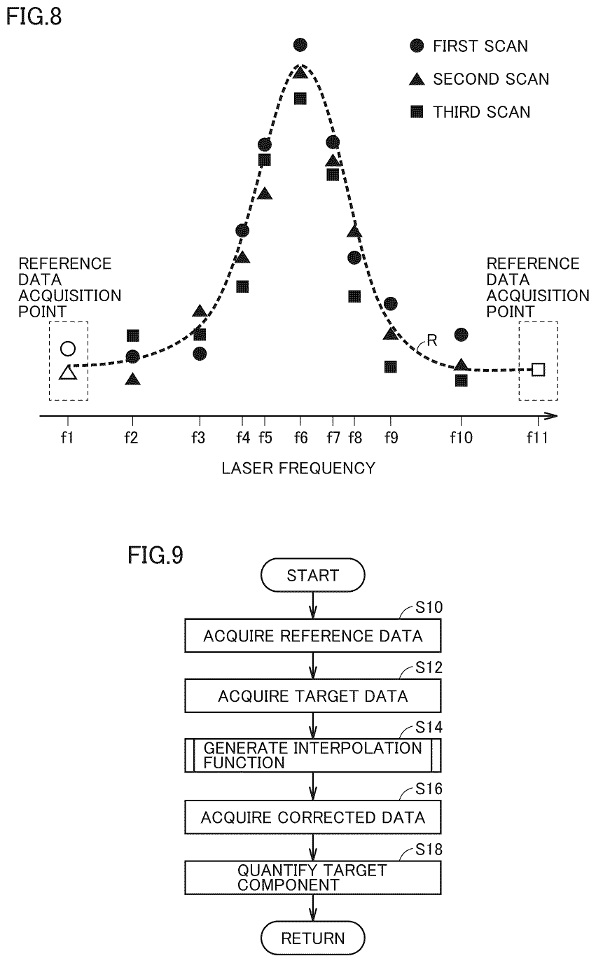

FIG. 8 is for explaining an example of the timing of acquiring reference data when acquiring an absorption spectrum. A broken line R in FIG. 8 indicates an absorption spectrum. In FIG. 8, filled plots indicate the timing of obtaining target data, and unfilled plots indicate the timing of obtaining reference data. The horizontal axis of FIG. 8 is the laser frequency.

In FIG. 8, in order to create the absorption spectrum R, ring-down signals are acquired at 11 laser frequencies from f1 to f11. Acquiring ring-down signals by changing the laser frequency stepwise upward or downward is referred to as a scan.

In FIG. 8, the controller 70 acquires a ring-down signal at a laser frequency f1. The ring-down signal is used as first reference data.

Next, the laser frequency is increased, and ring-down signals are sequentially acquired at laser frequencies f2 to f10. The ring-down signals obtained here are corrected by an interpolation function created based on the first reference data.

The controller 70 acquires a ring-down signal at a laser frequency f11. The ring-down signal is used as second reference data.

The controller 70 sequentially acquires ring-down signals at laser frequencies f2 to f10 by decreasing the laser frequency stepwise from the laser frequency f11. The target data obtained here is corrected by an interpolation function created based on the second reference data.

The controller 70 acquires a ring-down signal again at the laser frequency f1. The ring-down signal is used as third reference data.

Next, the laser frequency is increased, and ring-down signals are sequentially acquired at laser frequencies f2 to f10. The ring-down signals obtained here are corrected by an interpolation function created based on the third reference data.

When three scans are performed to obtain one absorption spectrum as shown in FIG. 8, for example, by using the data obtained at the start of a scan as reference data, it is possible to prevent the timing of acquiring target data and the timing of acquiring reference data from being temporally separated.

The timing of acquiring the reference data and the target data shown in FIG. 8 is an example, and is not limited to this. For example, a ring-down signal obtained at a laser frequency f6 in FIG. 8 may be used as the reference data.

### Saturated Absorption Cavity Ring-Down Spectroscopy

The data processing method according to the present embodiment can also be applied to data obtained by measurement by saturated-absorption cavity ring-down spectroscopy (SCAR), which is a type of CRDS. SCAR will be briefly described.

SCAR is a CRDS using saturated absorption that occurs by putting strong light into a resonator using high-intensity laser light and saturating the absorption of molecules. By using SCAR, even if an optical system such as a resonator drifts during measurement, a decay component due to gas absorption can be extracted without being affected by it.

In a measurement by SCAR, not only the exponential decay of the laser light but also a saturated absorption component, which is a non-linear component, is detected. Therefore, a ring-down signal shows a non-linear time change in a measurement by SCAR. A ring-down signal S(t) in SCAR is expressed by differential equations such as the following equations (7) and (8).

$$\begin{matrix}( Equation 4 ) & \\ S ( t ) = {A}_{d} exp ( - {γ}_{c} t ) f ( t ; {γ}_{c} , {γ}_{ℊ} , Z , \overline{V} ) + B & ( 7 )\end{matrix}$$

$$\begin{matrix}( Equation 5 ) & \\ f = - {γ}_{ℊ} \frac{In [ 1 + {A}_{d} Z \overline{V} ( v - {v}_{0} ) exp ( - {γ}_{c} t ) f ]}{{A}_{d} Z \overline{V} ( v - {v}_{0} ) exp ( - {γ}_{c} t )} & ( 8 )\end{matrix}$$

In equations (7) and (8), Ad represents the signal intensity, B represents the offset, γc represents the decay component due to the resonator, γg represents the decay component due to gas absorption, and Z represents the saturation parameter (the intensity of light inside the resonator). Thus, since there are two parameters, γc and γg, even if an optical system such as a resonator drifts during measurement, it is possible to extract the decay component due to gas absorption without being affected by it.

Measurement data Sd(t) obtained by a photodetector in a measurement by SCAR is expressed by the following equation (9).

$$\begin{matrix}( Equation 6 ) & \\ Sd ( t ) = Se ( t ) + Ss ( t ) + N ( Sd ( t ) ) & ( 9 )\end{matrix}$$

In equation (9), Se(t) is the exponential decay of the laser light, N(Sd(t)) is the non-linear component of the photodetector, and Ss(t) is the saturated absorption component.

In the case of SCAR, in addition to the CRDS measurement data shown in equation (6), a saturated absorption component is included in the measurement data.

As shown in equation (9), the data acquired by a measurement by SCAR, similarly to the data acquired by a measurement by CRDS, includes the non-linear component of the photodetector. Therefore, in order to improve the measurement accuracy, it is desirable that the non-linear component of the photodetector is removed from the measurement data.

In the case of a measurement by SCAR, the measurement data includes a saturated absorption component, which is a non-linear component. Therefore, it is more susceptible to the influence of the non-linearity of the photodetector than a measurement by CRDS.

Also, when correcting target data obtained by a measurement by SCAR by a method using a model function, in order to exclude the influence of saturated absorption, it is required to determine the parameters of the model function based on reference data measured in a vacuum state without a sample gas. However, when a sample gas is put into the cell 30 in order to measure the target data after the measurement of the reference data, the light is refracted by the sample gas, and the position and angle of the light incident on the photodetector 60 change. Therefore, the non-linear component of the photodetector 60 in the target data may be different from the non-linear component of the resonator 40 in the reference data. In such a case, even if the concentration of the target component of the sample gas is measured using the target data corrected based on the reference data, the measurement accuracy may decrease.

Furthermore, since the non-linearity of the detector changes over time, it is necessary to update the parameters of the model function after a certain period of time has elapsed since the parameters were acquired. In order to update the parameters, as described above, it is necessary to make the inside of the cell 30 a vacuum state without a sample gas. Therefore, the work of evacuating the inside of the cell at regular intervals occurs, which may be a work burden for the user.

In the data processing method according to the embodiment, the non-linear component of the detector can be removed from the target data without using a model function. Since the correction accuracy of the target data can be improved, the measurement accuracy of the target component in the sample gas can be improved.

Also, in the data processing method according to the embodiment, data obtained in a state where the sample gas is sealed in the cell 30 can be used as reference data. Therefore, it is possible to prevent the non-linear component of the photodetector 60 in the target data from being different from the non-linear component of the resonator 40 in the reference data due to putting the sample gas into the cell 30. As a result, the correction accuracy can be improved.

Furthermore, in the data processing method according to the present embodiment, it is not necessary to evacuate the inside of the cell 30 in the measurement for creating the interpolation function. Therefore, the burden of the user's work of evacuating the cell 30 can be reduced.

In SCAR, as shown in equation (9), the reference data includes a saturated absorption component in addition to the non-linear component of the photodetector. Therefore, when the data processing method according to the embodiment is applied to target data obtained by a measurement by SCAR, the non-linear component of the photodetector and the saturated absorption component in the reference data are removed.

Therefore, the corrected data obtained by applying the data processing method according to the embodiment to target data obtained by a measurement by SCAR includes the difference between the saturated absorption component of the reference data and the saturated absorption component of the target data, in addition to the exponential decay of the laser light.

### Flowchart of Data Correction Processing

Hereinafter, the flow of data correction processing executed in the controller 70 will be described. FIG. 9 is a flowchart showing the data correction processing performed by the controller 70. In one implementation example, the processing of FIG. 9 is called from a main routine and executed by starting a data correction processing application program in the controller 70.

Referring to FIG. 9, in step S10, the controller 70 acquires reference data. The reference data is, for example, a ring-down signal acquired using laser light of a laser frequency at which absorption by the sample gas is weak, in a state where the cell 30 is filled with the sample gas.

In step S12, the controller 70 acquires target data to be corrected. The target data is, for example, a ring-down signal acquired using laser light of a laser frequency at which absorption by the sample gas is strong, in a state where the cell 30 is filled with the sample gas.

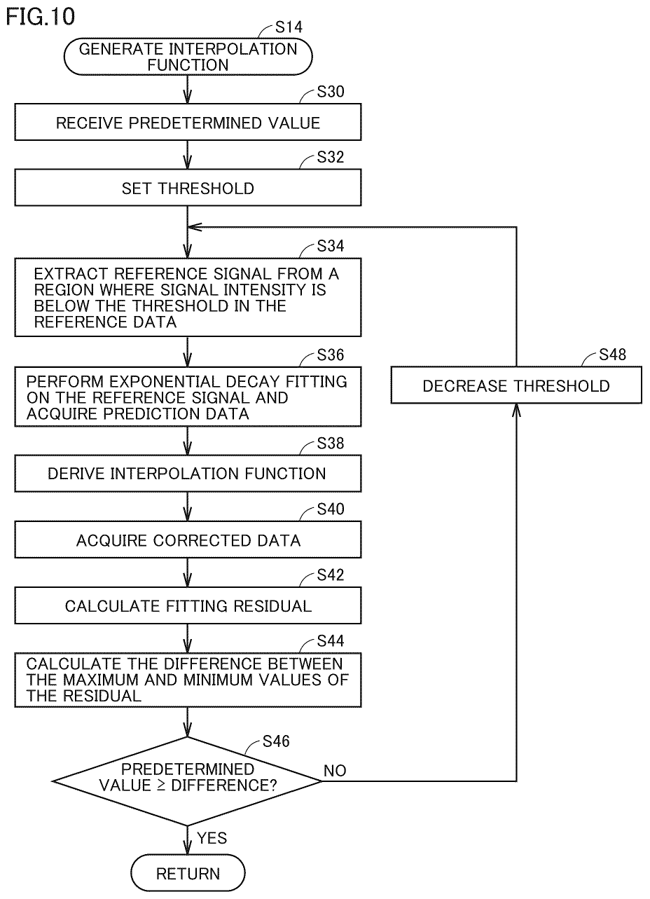

In step S14, the controller 70 generates an interpolation function. FIG. 10 shows a subroutine for generating the interpolation function in step S14.

Referring to FIG. 10, in step S30, the controller 70 receives a predetermined value. The predetermined value may be set in advance, or may be input by a user via an input device (not shown).

In step S32, the controller 70 sets a threshold for the signal intensity. The threshold may be set in advance, or may be input by a user via an input device (not shown).

In step S34, the controller 70 extracts a reference signal from a region where the signal intensity is equal to or less than the threshold in the reference data acquired in step S10.

In step S36, the controller 70 performs an exponential decay fitting on the reference signal extracted in step S34 and acquires prediction data.

In step S38, the controller 70 derives an interpolation function showing the correspondence relationship between the prediction data acquired in step S36 and the reference data acquired in step S10. The interpolation function shows the difference value between the prediction data and the reference data corresponding to the signal intensity of the reference data.

In step S40, the controller 70 corrects the target data acquired in step S12 using the interpolation function derived in step S38. The controller 70 acquires corrected data by adding the value of the corresponding interpolation function to the signal intensity of the target data.

In step S42, the controller 70 fits the corrected data acquired in step S40 to an exponential function and calculates a fitting residual.

In step S44, the controller 70 calculates the difference between the maximum value and the minimum value of the fitting residual calculated in step S42.

In step S46, the controller 70 determines whether the predetermined value received in step S30 is equal to or greater than the difference calculated in step S44. If the predetermined value is equal to or greater than the difference (YES in step S46), the controller 70 ends the subroutine for generating the interpolation function and returns the control to FIG. 9, and if not (NO in step S24), the controller 70 proceeds to step S48.

In step S48, the controller 70 lowers the set threshold and resets the threshold. The value by which the threshold is lowered may be a fixed value, or may be determined based on a ratio to the original threshold.

Referring to FIG. 9, in step S16, the controller 70 corrects the target data acquired in step S12 using the interpolation function generated in step S14 and acquires corrected data.

In step S18, the controller 70 quantifies the target component in the sample gas based on the corrected data acquired in step S16. Thereafter, the controller 70 ends the processing of FIG. 11 and returns the control to the main routine.

According to the present disclosure, the non-linear component of the detector can be removed from the target data without using a model function. Since the correction accuracy of the target data can be improved, the measurement accuracy of the target component in the sample gas can be improved.

Also, in the data processing method according to the embodiment, data obtained in a state where the sample gas is sealed in the cell 30 can be used as reference data. Therefore, it is possible to prevent the non-linear component of the photodetector in the target data from being different from the non-linear component of the resonator in the reference data due to putting the sample gas into the cell. As a result, the correction accuracy can be improved.

Furthermore, in the data processing method according to the present embodiment, it is not necessary to evacuate the inside of the cell in the measurement for creating the interpolation function. Therefore, the burden of the user's work of evacuating the cell can be reduced.

CRDS is used, for example, for the measurement of trace components contained in a sample gas. For example, according to CRDS, by utilizing the fact that the wavelength of infrared light absorbed differs depending on the isotopes constituting a molecule, the analysis of isotope molecules can be performed. Radiocarbon isotope 14C, which is the only long-lived radioisotope among the isotopes of elements, is used as an environmental tracer. By measuring the abundance ratio of 14C in an organic resource, it can be determined whether the organic resource is derived from biomass from plants or from fossil fuels. 14C is also used as a biological tracer. In drug development, by administering a compound in which a part of the carbon of the compound is labeled with 14C to a living body and measuring the concentration of 14C accumulated in its blood, urine, feces, and organs, the pharmacokinetics of the administered compound can be analyzed. However, the isotopic ratio of 14C is very low. Therefore, in order to measure 14C, it is necessary to distinguish it from other isotopes of carbon and measure 14C with high accuracy. According to the data processing method of the present disclosure, it is possible to improve the measurement accuracy of 14C in organic resources.

### Aspects

It will be understood by those skilled in the art that the plurality of exemplary embodiments described above are specific examples of the following aspects.

(Item 1) A data processing method according to one aspect is a data processing method for correcting target data obtained by a gas absorption spectroscopy method using a resonator, and may include a step of acquiring reference data, a step of acquiring the target data, a step of generating an interpolation function based on the reference data, a step of acquiring corrected data by correcting the target data based on the interpolation function, and a step of quantifying a target component based on the corrected data, wherein the step of generating the interpolation function has a step of extracting a reference signal from a region where a signal intensity is equal to or less than a threshold in the reference data, a step of predicting the signal intensity of the reference data based on the reference signal and acquiring prediction data, and a step of deriving a correspondence relationship between the prediction data and the reference data as the interpolation function.

According to the data processing method of item 1, measurement data obtained by gas absorption spectroscopy can be corrected without using a model function.

(Item 2) In the data processing method according to item 1, the step of deriving may include a step of calculating a difference between the prediction data and the reference data.

According to the data processing method of item 2, an interpolation function is derived using the difference between prediction data and reference data.

(Item 3) In the data processing method according to item 1 or 2, the step of acquiring the prediction data may include a step of performing an exponential decay fitting on the reference signal.

According to the data processing method of item 3, an interpolation function is derived using prediction data obtained by performing an exponential decay fitting on a reference signal, which is a part of reference data.

(Item 4) In the data processing method according to any one of items 1 to 3, the step of generating the interpolation function may further include a step of calculating a residual by performing an exponential function fitting on the corrected data, a step of calculating a difference between a maximum value and a minimum value in the residual, and a step of reducing the threshold when the difference is equal to or greater than a predetermined value.

According to the data processing method of item 4, the validity of the threshold is judged based on the difference between the maximum value and the minimum value of the fitting residual calculated by performing an exponential function fitting on the corrected data. According to the interpolation function generated by reducing the threshold, the non-linear component of the target data can be further removed.

(Item 5) In the data processing method according to item 4, the step of generating the interpolation function may further include a step of receiving the predetermined value.

According to the data processing method of item 5, the validity of the threshold is judged based on the predetermined value. For example, the user can adjust the degree of removal of the non-linear component in the correction by inputting the predetermined value.

(Item 6) In the data processing method according to item 4, the predetermined value may be 2 μV or less.

According to the data processing method of item 6, an interpolation function is generated such that the difference between the maximum value and the minimum value of the fitting residual calculated by performing an exponential function fitting on the corrected data is 2 μV or less.

(Item 7) In the data processing method according to any one of items 1 to 6, the reference data may include a ring-down signal representing a time change of signal intensity.

According to the data processing method of item 7, data processing is performed based on reference data including a ring-down signal showing an exponential decay.

(Item 8) In the data processing method according to any one of items 1 to 7, the gas absorption spectroscopy method may be saturated-absorption cavity ring-down spectroscopy (SCAR).

According to the data processing method of item 8, the non-linear component of the photodetector contained in the target data obtained by a measurement by SCAR can be removed.

(Item 9) In the data processing method according to any one of items 1 to 8, the reference data may be obtained by an indium antimonide (InSb) detector or an MCT (Mercury cadmium telluride) detector.

According to the data processing method of item 9, the non-linear component due to an indium antimonide (InSb) detector or an MCT (Mercury cadmium telluride) detector contained in the target data can be removed.

(Item 10) A program according to one aspect may cause a computer to execute the data processing method according to any one of items 1 to 9 by being executed by a processor mounted on the computer.

According to the program of item 10, measurement data obtained by gas absorption spectroscopy can be corrected without using a model function.

(Item 11) A processing apparatus according to one aspect may include at least one or more processors and a memory accessible to the one or more processors, the memory may store one or more instructions to be executed by the processors, and the processors, by executing the one or more instructions, may acquire reference data, acquire target data, generate an interpolation function based on the reference data, correct the target data based on the interpolation function, acquire corrected data, quantify a target component based on the corrected data, and when generating the interpolation function, extract a reference signal from a region where a signal intensity is equal to or less than a threshold in the reference data, predict the signal intensity of the reference data based on the reference signal, acquire prediction data, and derive a correspondence relationship between the prediction data and the reference data as the interpolation function.

According to the processing apparatus of item 11, measurement data obtained by gas absorption spectroscopy can be corrected without using a model function.

(Item 12) A gas absorption spectroscopy system according to one aspect is a gas absorption spectroscopy system for quantifying a target component in a gas contained in a cell, and may include a resonator including a plurality of mirrors arranged such that light is reflected between them inside the cell, a light source that irradiates the resonator with laser light, a detector that detects light extracted from the resonator, and a control device that receives a detection signal from the detector, wherein the control device acquires reference data, acquires target data, generates an interpolation function based on the reference data, corrects the target data based on the interpolation function, acquires corrected data, quantifies the target component based on the corrected data, and when generating the interpolation function, extracts a reference signal from a region where a signal intensity is equal to or less than a threshold in the reference data, predicts the signal intensity of the reference data based on the reference signal, acquires prediction data, and derives a correspondence relationship between the prediction data and the reference data as the interpolation function.

According to the gas absorption spectroscopy system of item 12, measurement data obtained by gas absorption spectroscopy can be corrected without using a model function.

The embodiments disclosed this time should be considered to be illustrative in all respects and not restrictive. The scope of the present disclosure is indicated by the claims rather than by the description of the embodiments, and it is intended that all modifications within the meaning and scope equivalent to the claims are included. Also, it is intended that each technology in the embodiments can be implemented alone or in combination with other technologies in the embodiments as much as possible as needed.

### Description of the Reference Numerals

10 Laser light source, 11 QCL, 12 Laser driver, 30 Cell, 31 Introduction pipe, 32 Discharge pipe, 33 Introduction valve, 34 Discharge valve, 40 Resonator, 41, 42 Mirror, 50 Mirror driving device, 60 Photodetector, 70 Controller, 71 Processor, 72 Memory, 100 Gas absorption spectroscopy system.

1. A data processing method for correcting target data obtained by a gas absorption spectroscopy method using a resonator, the method comprising: a step of acquiring reference data; a step of acquiring the target data; a step of generating an interpolation function based on the reference data; a step of acquiring corrected data by correcting the target data based on the interpolation function; and a step of quantifying a target component based on the corrected data, wherein the step of generating the interpolation function comprises: a step of extracting a reference signal from a region where a signal intensity is equal to or less than a threshold in the reference data; a step of predicting the signal intensity of the reference data based on the reference signal and acquiring prediction data; and a step of deriving a correspondence relationship between the prediction data and the reference data as the interpolation function.

2. The data processing method according to claim 1, wherein the step of deriving comprises a step of calculating a difference between the prediction data and the reference data.

3. The data processing method according to claim 1, wherein the step of acquiring the prediction data comprises a step of performing an exponential decay fitting on the reference signal.

4. The data processing method according to claim 1, wherein the step of generating the interpolation function further comprises: a step of calculating a residual by performing an exponential function fitting on the corrected data; a step of calculating a difference between a maximum value and a minimum value in the residual; and a step of reducing the threshold when the difference is equal to or greater than a predetermined value.

5. The data processing method according to claim 4, wherein the step of generating the interpolation function further comprises a step of receiving the predetermined value.

6. The data processing method according to claim 4, wherein the predetermined value is 2 μV or less.

7. The data processing method according to claim 1, wherein the reference data includes a ring-down signal representing a time change of signal intensity.

8. The data processing method according to claim 1, wherein the gas absorption spectroscopy method is saturated-absorption cavity ring-down spectroscopy (SCAR).

9. The data processing method according to claim 1, wherein the reference data is obtained by an indium antimonide (InSb) detector or an MCT (Mercury cadmium telluride) detector.

10. A non-transitory computer-readable recording medium storing a program that, when executed by a processor mounted on a computer, causes the computer to execute the data processing method according to claim 1.

11. A processing apparatus, comprising: at least one or more processors; and a memory accessible to the one or more processors, wherein the memory stores one or more instructions to be executed by the processors, and the processors, by executing the one or more instructions: acquire reference data; acquire target data; generate an interpolation function based on the reference data; correct the target data based on the interpolation function and acquire corrected data; quantify a target component based on the corrected data; and when generating the interpolation function: extract a reference signal from a region where a signal intensity is equal to or less than a threshold in the reference data; predict the signal intensity of the reference data based on the reference signal and acquire prediction data; and derive a correspondence relationship between the prediction data and the reference data as the interpolation function.

12. A gas absorption spectroscopy system for quantifying a target component in a gas contained in a cell, the system comprising: a resonator including a plurality of mirrors arranged such that light is reflected between them inside the cell; a light source configured to irradiate the resonator with laser light; a detector configured to detect light extracted from the resonator; and a control device configured to receive a detection signal from the detector, wherein the control device is configured to: acquire reference data; acquire target data; generate an interpolation function based on the reference data; correct the target data based on the interpolation function and acquire corrected data; quantify the target component based on the corrected data; and when generating the interpolation function: extract a reference signal from a region where a signal intensity is equal to or less than a threshold in the reference data; predict the signal intensity of the reference data based on the reference signal and acquire prediction data; and derive a correspondence relationship between the prediction data and the reference data as the interpolation function.
